(19) United States
(12) Patent Application Publication
(10) Pub. No.: US 2004/0009874 A1
(43) Pub. Date: Jan. 15, 2004

(54) Catalyst module for high-temperature denitration apparatus

(75) Inventors: Hitoshi Koike, Funabashi-shi (JP); Masahiro Takeuchi, Funabashi-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Ishikawajima-Harima Heavy Industries Co., Ltd., Tokyo (JP)

(21) Appl. No.: 10/444,958

(22) Filed: May 27, 2003

(30) Foreign Application Priority Data
Jun. 20, 2002 (JP) 2002-180426

(51) Int. Cl. B01J 23/02

(52) U.S. Cl. 502/439

(57) ABSTRACT

A plurality of shell frame panels are assembled into a box-shaped unit with front and rear open ends. Each of the shell frame panels has a picture-frame-like shell frame and shell plates mounted to the shell frame so as to be slidable upon thermal expansion. Catalysts are charged in the box-shaped unit and supported by the shell frames. In use, the shell plates low in thermal capacity rapidly rise in temperature and try to expand. The box-shaped unit is adapted such that such expansion of the shell plates is not blocked by the shell frames higher in thermal capacity then the shell plates. As a result, no bucking of the shell plates occurs and the catalysts are prevented from being broken.

### BACKGROUND OF THE INVENTION

1. Field of the Invention

The present invention relates to a catalyst module for a high-temperature denitration apparatus.

2. Description of the Related Art

A conventional denitration apparatus for boiler exhaust gas generally comprises, as shown in FIGS. 1 and 2, a box-shaped casing 1 with front and rear open ends for passage of exhaust gas from a boiler (not shown) and a frame body 2 in the casing 1.

The frame body 2 comprises a plurality of vertical frame members 3 erected in a spaced-apart relationship widthwise and in a direction of exhaust gas flow of the casing 1 and a plurality of horizontal frame members 4 fixed to the vertical frame members 3 through welding into a latticework. Thus, spaces 5 to be filled or charged with catalysts are formed in a plurality of widthwise rows and in a plurality of vertical stages within the casing 1, brace members 6 being welded to interconnect slantwise the frame members 3 and 4 for reinforcement against horizontal forces generated for example in an earthquake. A plurality of (two in the example shown in FIG. 2) such frame bodies 2 with the same construction are arranged and interconnected in the direction of exhaust gas flow.

The casing 1 is internally lined with thermal insulation material 7, and upon operation, temperature difference is caused between the casing 1 and the frame body 2 so that a degree in thermal expansion of the latter is greater than that of the former. Such difference in thermal expansion between the casing 1 and the frame body 2 upon operation may be absorbed such that the frame body 2 is supported in the casing 1 partly by fixed supports 8 and partly by slide supports 9 so as to make the frame body 2 slidable widthwise and in the direction of exhaust gas flow of the casing 1.

A catalyst port 11 with an openable lid 10 protrudes from a top of the casing 1. With the lid 10 being opened, catalyst modules 12 each charged with catalysts are suspended for example by cranes as shown in FIG. 2 and are set in the spaces 5 within the frame bodies 2.

Each of the conventional catalyst modules 12 comprises, as shown in FIGS. 3 to 5, top, base and side panels 17, 18 and 19 assembled into a box-shaped unit 20 with front and rear open ends. Each of the panels 17, 18 and 19 comprises square steel tubes 13 and angle steels 14a which are assembled into a shell frame 15 as well as a shell plate or plates 16 directly welded to the shell frame 15. The box-shaped unit 20 is charged with a plurality of catalysts 21 such that the catalysts 21 are supported by the shell plates 16. Latticed frames 22 are mounted to the opened front and rear ends of the box-shaped unit 20. Restorably compressed members 23 and 24 are interposed between the catalysts 21 and the panels 17, 18 and 19 and between the adjacent catalysts 21 so as to fill gaps generable due to thermal expansion of the box-shaped unit 20.

Recently, a gas turbine is frequently used for generation of electricity and in such a case, exhaust gas from the gas turbine must be denitrated. To this end, it has been envisaged that, as a high-temperature denitration apparatus for gas-turbine exhaust gas, the above-mentioned denitration apparatus for boiler exhaust gas is utilized, with no structural change and with material of which the members 3, 4 and 6 are made being changed from carbon steel to stainless steel.

However, in the case of a high-temperature denitration apparatus for gas-turbine exhaust gas, in use, a rising velocity of inlet gas temperature is extremely swift as compared with that in the conventional denitration apparatus for boiler exhaust gas, and the operation period is as short as about 15 minutes. As a result, in the box-shaped unit 20 of the catalyst module 12, the shell plates 16 low in thermal capacity rapidly rise in temperature and try to expand; however, such expansion of the shell plates 16 is blocked by the shell frames 15 which are higher in thermal capacity than the shell plates 16, which may cause buckling of the shell plates 16 and breakages of the catalysts 21 supported in the unit 20 by the shell plates 16.

The invention was made in view of the above and has its object to provide a catalyst module for a high-temperature denitration apparatus which can avoid buckling of shell plates in a box-shaped unit of the catalyst module due to rapid temperature change in use, thereby preventing catalysts from being broken.

### BRIEF SUMMARY OF THE INVENTION

The invention is directed to a catalyst module for a high-temperature denitration apparatus comprising a plurality of shall frame panels assembled into a box-shaped unit with front and rear open ends, each of the shell frame panels comprising a picture-frame-like shell frame and at least a shell plate mounted to the shell frame so as to be slidable upon thermal expansion, catalysts being charged in the box-shaped unit and supported by the shell frames.

According to the invention, when, in use, the shell plates in the box-shaped unit which are low in thermal capacity rapidly rise in temperature and try to expand, such expansion is not blocked by the shell frames which are higher in thermal capacity than the shell plates since the shell plates are mounted to the shell frames so as to be slidable upon thermal expansion. As a result, no buckling of the shell plates occurs and there is no fear of the catalysts being broken since the catalysts are supported in the box-shaped unit by the shell frames.

A preferred embodiment of the invention will be described in conjunction with the drawings.

### BRIEF DESCRIPTION OF THE DRAWINGS

FIG. 1 is a front view of a conventional denitration apparatus;

FIG. 2 is a view looking in the direction of arrows II in FIG. 1;

FIG. 3 is a perspective view showing a conventional catalyst module;

FIG. 4 is a side view of the conventional catalyst module shown in FIG. 3;

FIG. 5 is a horizontal sectional view taken along lines V-V in FIG. 4;

FIG. 6 is a perspective view showing an embodiment of the invention;

FIG. 7 is an exploded view of the embodiment shown in FIG. 6;

FIG. 8 is a side view of the embodiment shown in FIG. 6;

FIG. 9 is a horizontal sectional view taken along lines IX-IX in FIG. 8; and

FIG. 10 is a sectional view taken along lines X-X in FIG. 8.

### DETAILED DESCRIPTION OF THE PREFERRED EMBODIMENT

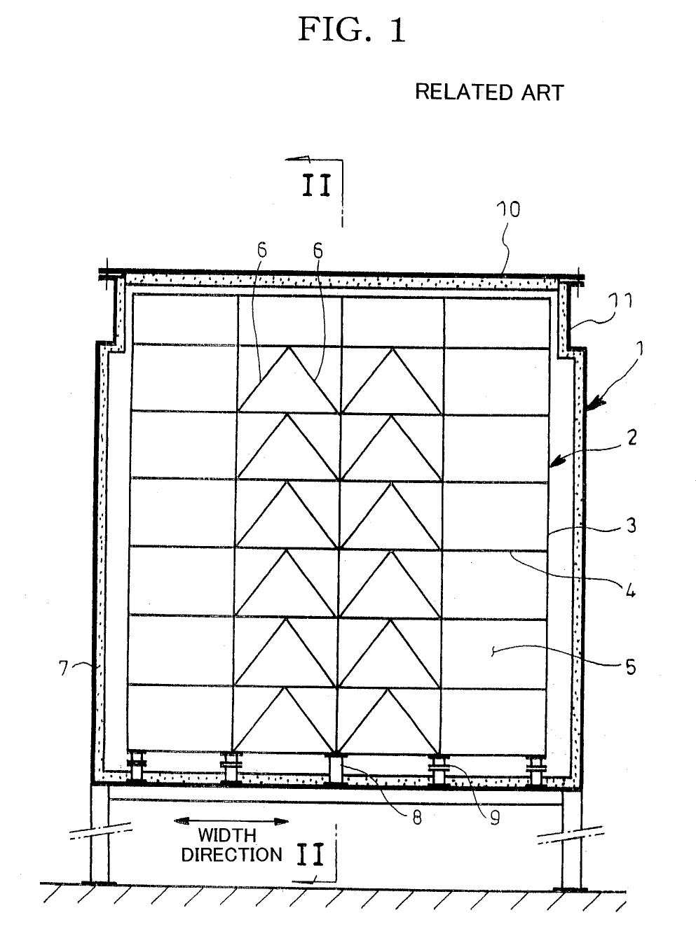

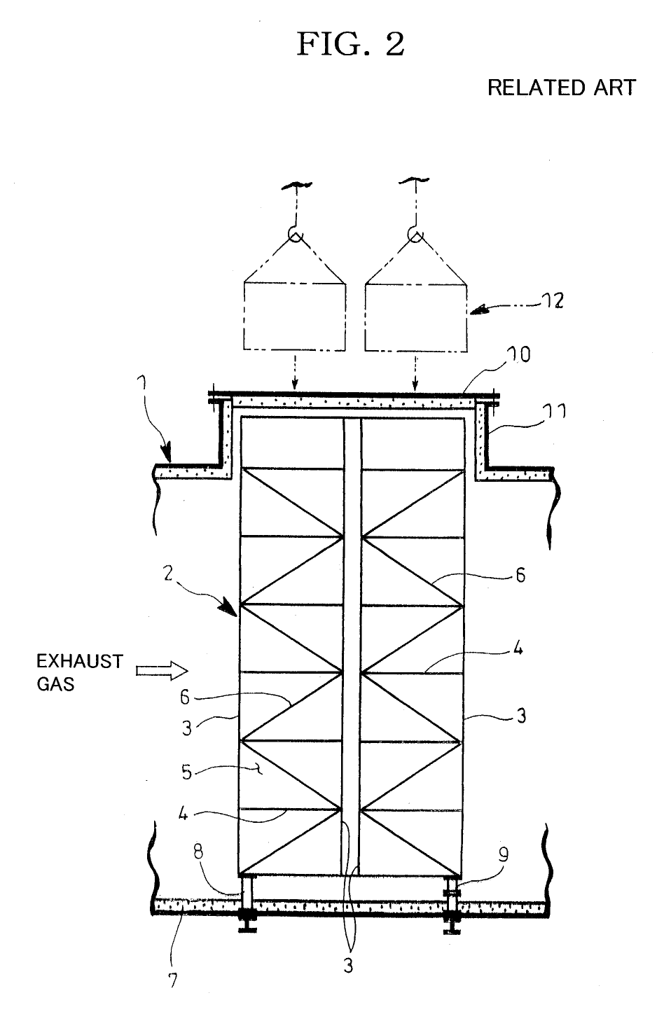

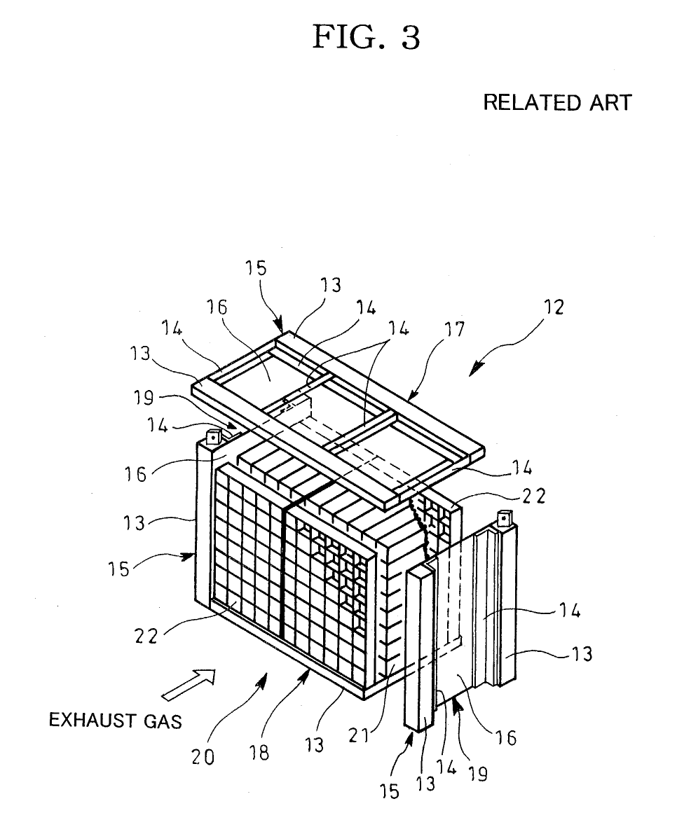

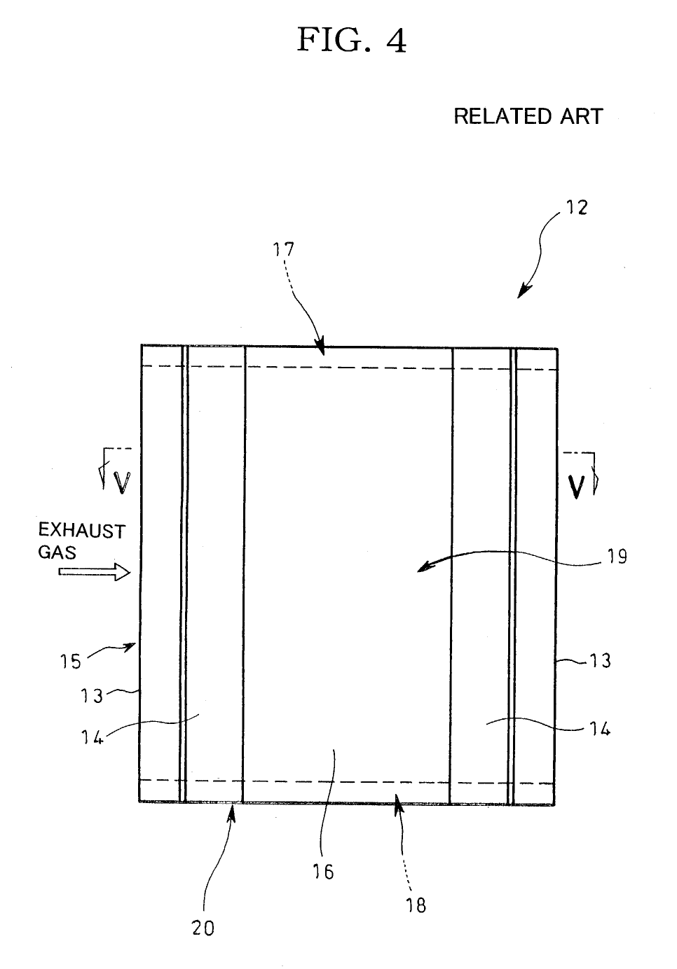

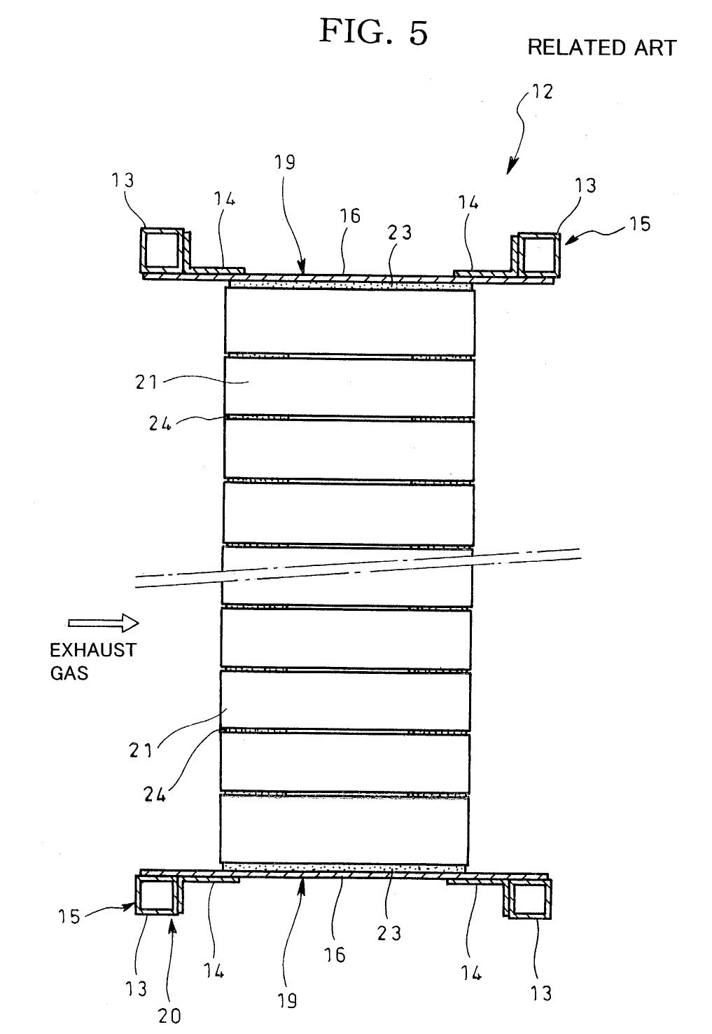

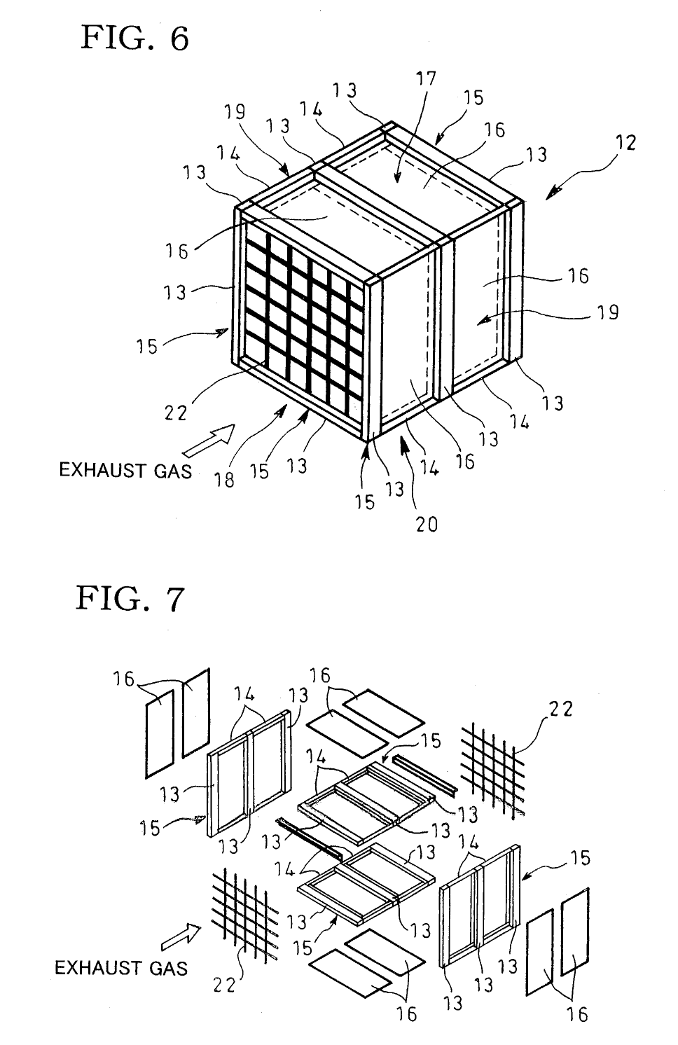

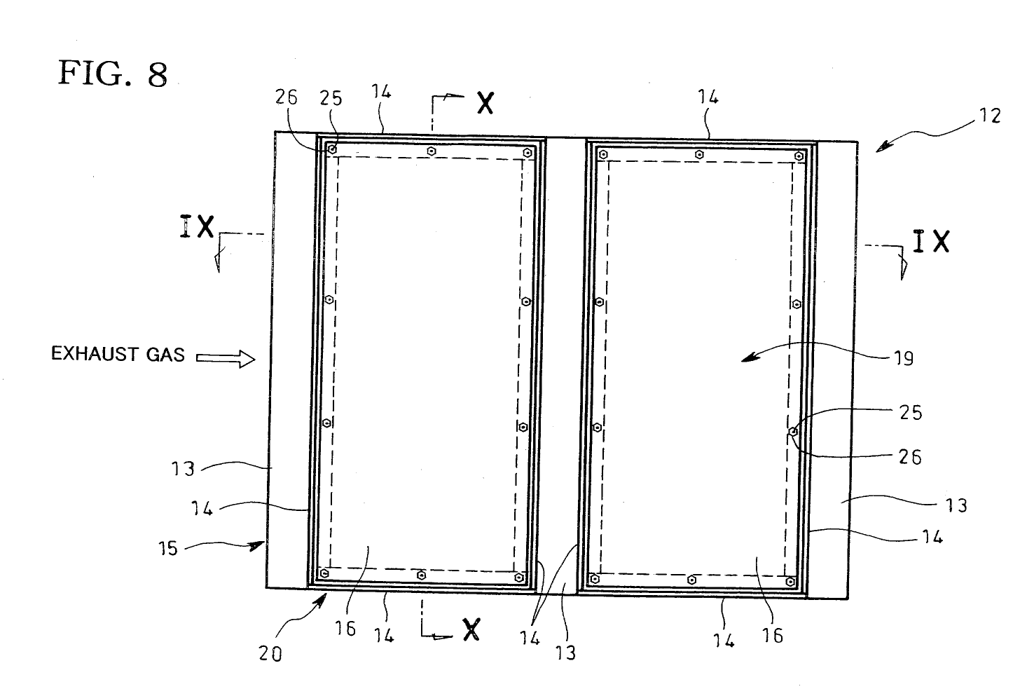

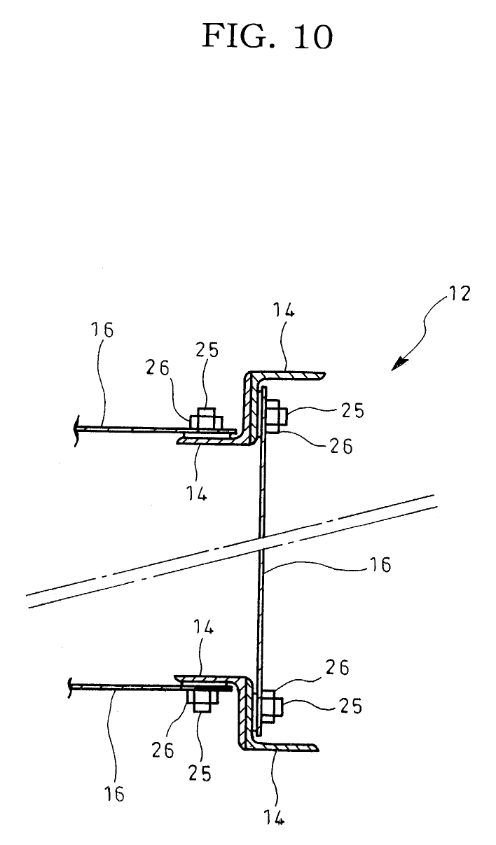

FIGS. 6 to 10 show an embodiment of the invention in which parts similar to those in FIGS. 1 to 5 are represented by the same reference numerals and which is basically similar in structure to that in the related art shown in FIGS. 1 to 5. This embodiment resides in that, as shown in FIGS. 6 to 10, top, base and side panels 17, 18 and 19 as shall frame panels are assembled into a box-shaped unit 20 with front and rear open ends; each of the shell frame panels 17, 18 and 19 comprises square steel tubes 13 and angle steels 14 which are assembled into a picture-frame-like shell frame 15 as well as shell plates 16 mounted to the shell frame 15 so as to be slidable upon thermal expansion; and catalysts are charged in the box-shaped unit 20 and supported by the shell frames 15.

In the embodiment shown, each of the shell plates 16 has a rim formed with openings (not shown) which are larger in radius than bolts 25 protruded from the angle steels 14. The bolts 25 of the angle steels 14 of the shell frame 15 are passed through the rim openings of the shell plates 16, and nuts 26 are screwed up onto the bolts 25 so that the shell plates 16 are mounted to the shell frame 15 so as to be slidable upon thermal expansion.

Interposed between the catalysts 21 and the panels 17, 18 and 19 and between the adjacent catalysts 21 are restorably compressed members 23 and 24, respectively, so as to fill gaps generable due to thermal expansion of the box-shaped unit 20. The restorably compressed member 23 may be a mat made of ceramic fiber with a diameter of tens of μm or less; the restorably compressed member 24 may be a sheet of paper made of the ceramic fiber.

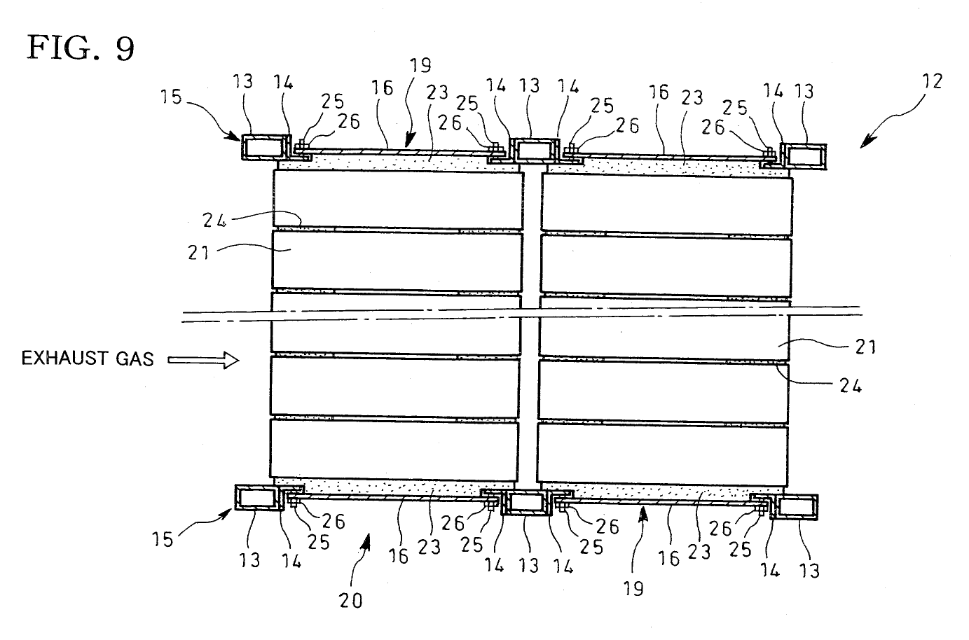

In the embodiment, the catalysts 21 are arranged in two files in the direction of exhaust gas flow as shown in FIG. 9; alternatively, the catalysts 21 may be arranged in a single file or in three or more files in the direction of exhaust gas flow. In the embodiment, two shell plates 16 are mounted to each of the panels 17, 18 and 19; the number of the plates 16 may be decreased to one or increased three or more.

In use, the shell plates 16 of the box-shaped unit 20 low in thermal capacity rapidly rise in temperature and try to expand. Such expansion of the shell plates 16 is not blocked by the shell frames 15 which are higher in thermal capacity than the shell plates 16 since the shell plates 16 are mounted to the shell frames 15 so as to be slidable upon thermal expansion. Thus, no bucking of the shell plates 16 occurs and the catalysts 21 charged in the box-shaped unit 20 are not broken since the catalysts 21 are supported by the shell frames 15.

The catalysts 21 charged in the box-shaped unit 20 are retained stably with no jounces since the gaps generable between the catalysts 21 and the panels 17, 18 and 19 and between the adjacent catalysts 21 upon thermal expansion of the box-shaped unit 20 are filled by the restorably compressed members 23 and 24.

Thus, any bucking of the shell plates 16 in the catalyst module 12 due to rapid temperature change is averted in use to prevent breakages of the catalysts 21.

It is to be understood that a catalyst module for a high-temperature denitration apparatus according to the invention is not limited to the above-mentioned embodiment and that various changes and modifications may be made without deferring from the scope and spirit of the invention.

As is clear from the foregoing, in a catalyst module for a high-temperature denitration apparatus according to the invention, buckling of shell plates of a box-shaped unit in a catalyst module due to rapid temperature change is averted in use to prevent breakages of catalysts.

What is claimed is:

1. A catalyst module for a high-temperature denitration apparatus comprising a plurality of shall frame panels assembled into a box-shaped unit with front and rear open ends, each of the shell frame panels comprising a picture-frame-like shell frame and at least a shell plate mounted to the shell frame so as to be slidable upon thermal expansion, catalysts being charged in the box-shaped unit and supported by the shell frames.
